(19) United States
(12) Patent Application Publication
(10) Pub. No.: US 2026/0227825 A1
(43) Pub. Date: Aug. 6, 2026

(54) DOCKING STATION THAT OUTPUTS OVERLAID DATA FROM MULTIPLE SOURCES

(71) Applicant: Synaptics Incorporated, San Jose, CA (US)

(72) Inventors: Szymon Stroba, Tarnowskie Góry (PL); Jeffrey Lukanc, San Jose, CA (US); Mark E. Miller, Mission Viejo, CA (US)

(73) Assignee: Synaptics Incorporated, San Jose, CA (US)

(21) Appl. No.: 19/650,211

(22) Filed: Apr. 16, 2026

Related U.S. Application Data
(63) Continuation-in-part of application No. 18/791,837, filed on Aug. 1, 2024.
Application No. 18/791,837 is a continuation of application No. 17/581,126, filed on Jan. 21, 2022, now Pat. No. 12,298,808.

(51) Int. Cl. G06F 1/16; G06F 8/65

(52) U.S. Cl. CPC G06F 1/1632; G06F 8/65

(57) ABSTRACT

A docking station is operable in a plurality of modes. The docking station obtains first data via a first interface configured to communicate with a computing device when operating in a first mode. The docking station obtains second data via a second interface when operating in a second mode. The docking station selectively outputs to a display via a third interface the first data when operating in the first mode, the second data when operating in the second mode, or the second data overlaid on at least a portion of the first data in response to the docking station operating in a third mode. The docking station determines when the computing device is not coupled to the docking station and, in response, operates in the second mode. The second data may be on-screen display data for an on-screen menu obtained from a processor associated with the docking station.

### CROSS REFERENCE TO RELATED APPLICATIONS

This application is a continuation-in-part of U.S. patent application Ser. No. 18/791,837, filed Aug. 1, 2024, titled “NETWORK-CAPABLE DOCKING STATION,” which is a continuation of U.S. patent application Ser. No. 17/581,126, filed Jan. 21, 2022, titled “NETWORK-CAPABLE DOCKING STATION” (now U.S. Pat. No. 12,298,808, granted May 13, 2025), both of which are incorporated by reference herein in their entireties.

### TECHNICAL FIELD

The present implementations relate generally to docking stations, and specifically to a docking station configured to communicate with various components and to support various applications.

### BACKGROUND OF RELATED ART

A docking station provides a simplified interface for coupling, or otherwise enabling, a computing device (such as a laptop) to communicate with various peripherals (e.g., monitors, a keyboard, mouse, and webcam) or other devices. However, existing docking stations have limited functionality when not connected to an external computing device. For example, to allow users to reserve a docking station in a public or communal space, the users would need to employ an existing hoteling application, which may require non-standard, specialized hardware to be placed near the docking station. As another example, to run diagnostics on such a docking station, a site administrator (or information technology (IT) professional) would need to couple a computing device (such as a laptop) to the docking station.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented as a method performed by a docking station operable in a plurality of modes. The method includes obtaining, by the docking station when operating in a first mode of a plurality of modes, first data via a first interface of the docking station, the first interface being configured to couple the docking station to a computing device. The method further includes obtaining, by the docking station when operating in a second mode of the plurality of modes, second data via a second interface of the docking station. The method further includes selectively outputting, to a display via a third interface of the docking station that is different from the first interface and the second interface, the first data in response to the docking station operating in the first mode, or the second data in response to the docking station operating in the second mode, or the second data overlaid on at least a portion of the first data in response to the docking station operating in a third mode. Selectively outputting may include determining that the computing device is not coupled to the docking station and operating in the second mode in response to determining that the computing device is not coupled to the docking station.

In some aspects, the second data may include on-screen display data for an on-screen menu that is obtained from a processor associated with the docking station.

In some aspects, the docking station may intercept human interface device (HID) commands for the on-screen menu of the display, and the processor associated with the docking station may control navigation and selection of the on-screen menu using intercepted HID commands. The processor associated with the docking station may output selection data from the selection of the on-screen menu to configure at least one of the display or systems of the docking station.

In some aspects, the processor associated with the docking station is embedded in the docking station, or the processor associated with the docking station is coupled to the docking station via a fourth interface of the docking station.

In some aspects, the processor associated with the docking station may be an artificial intelligence (AI) processor.

In some aspects, the docking station may include a memory configured to store on-screen display data for output to the display via the third interface of the docking station.

In some aspects, the second data may include picture-in-picture (PiP) video data.

In some aspects, the first data may include video data, and the docking station may provide the video data to a processor associated with the docking station. The docking station may obtain modified video data from the processor associated with the docking station after the processor associated with the docking station modifies the video data, and selectively output the modified video data to the display.

In some aspects, the docking station may obtain third data via one of the second interface or a fourth interface of the docking station configured to communicate with a peripheral device, and may provide the third data to a processor associated with the docking station. The docking station may obtain modified third data from the processor associated with the docking station after the processor associated with the docking station modifies the third data, and output the modified third data to the computing device via the first interface of the docking station.

Another innovative aspect of the subject matter of this disclosure can be implemented as a docking station that includes at least one processor, and a memory storing instructions. The instructions executed by the at least one processor cause the docking station to obtain, when operating in a first mode of a plurality of modes, first data via a first interface of the docking station, the first interface being configured to couple the docking station to a computing device. The docking station may be caused to obtain, when operating in a second mode of the plurality of modes, second data via a second interface of the docking station. The docking station may be further caused to selectively output, to a display via a third interface of the docking station that is different from the first interface and the second interface, the first data in response to the docking station operating in the first mode, or the second data in response to the docking station operating in the second mode, or the second data overlaid on at least a portion of the first data in response to the docking station operating in a third mode. The docking station may be further caused to determine that the computing device is not coupled to the docking station and operate in the second mode in response to determining that the computing device is not coupled to the docking station.

Another innovative aspect of the subject matter of this disclosure can be implemented as a system including a display and a docking station coupled to the display, where the docking station is operable in a plurality of modes. The docking station may be configured to obtain, when operating in a first mode of a plurality of modes, first data via a first interface of the docking station, the first interface being configured to couple the docking station to a computing device. The docking station may be further configured to obtain, when operating in a second mode of the plurality of modes, second data via a second interface of the docking station. The docking station may be further configured to selectively output, to the display via a third interface of the docking station that is different from the first interface and the second interface, the first data in response to the docking station operating in the first mode, or the second data in response to the docking station operating in the second mode, or the second data overlaid on at least a portion of the first data in response to the docking station operating in a third mode. The docking station may be further configured to determine that the computing device is not coupled to the docking station and to operate in the second mode in response to determining that the computing device is not coupled to the docking station.

### BRIEF DESCRIPTION OF THE DRAWINGS

The present embodiments are illustrated by way of example and are not intended to be limited by the figures of the accompanying drawings.

FIG. 1A shows a block diagram depicting an example configuration of a docking station, in accordance with some embodiments.

FIG. 1B shows a block diagram depicting an example configuration of a docking station, in accordance with some embodiments.

FIG. 1C shows a block diagram depicting an example configuration of a docking station, in accordance with some embodiments.

FIG. 2 shows a block diagram of a docking system, in accordance with some embodiments.

FIG. 3 shows an illustrative flowchart depicting an example method performed by a docking station, in accordance with some embodiments.

FIG. 4A shows an example application of a docking station operating in a second mode, in accordance with some embodiments.

FIG. 4B shows an example application of a docking station operating in a second mode, in accordance with some embodiments.

FIG. 4C shows an example application of a docking station operating in a third mode, in accordance with some embodiments.

FIG. 5A shows an example application of a docking station operating to receive first data from a computing device and second data from one or more different sources, and to output the first data and the second data to a display device for display, in accordance with some embodiments.

FIG. 5B shows an example application for a docking station to operate with an on-screen display framework for dynamic system configuration via communication with an embedded controller, in accordance with some embodiments.

FIG. 5C shows an example application of a docking station operating to overlay video from different sources without using a frame buffer, in accordance with some embodiments.

FIG. 5D shows an example application of a docking station operating to provide video path interception via a processor associated with the docking station for real-time video processing and enhancement, in accordance with some embodiments.

FIG. 5E shows an example application of a docking station operating to provide peripheral or network data interception via a processor associated with the docking station for real-time processing and enhancement, in accordance with some embodiments.

### DETAILED DESCRIPTION

In the following description, numerous specific details are set forth, such as examples of specific components, circuits, and processes, to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. The terms “first,” “second,” “third,” “fourth,” etc., as used herein, are not intended to indicate any sequence, amount, or importance, but rather to distinguish various components or configurations. The phrase “in lieu of,” as used herein, means “as an alternative to,” “rather than,” or “instead of,” and is not intended to indicate any sequence or order. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise, as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, perform one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the embodiments disclosed herein may be executed by one or more processors (or a processing system). The term “processor,” as used herein, may refer to any general-purpose processor, special-purpose processor, conventional processor, controller, microcontroller, and/or state machine capable of executing scripts or instructions of one or more software programs stored in memory.

Aspects of the disclosure relate to a docking station, sometimes generally referred to as a docking apparatus, that is capable of communicating with a network. As used herein, the term “docking station” or “docking apparatus” refers to any device or module that provides, for example, port replication, host switching (including KVM functionality), and/or multi-processor/multi-host connectivity, as discussed herein. It may be implemented as a standalone device or integrated directly into another component, such as a monitor, display, peripheral, or other electronic system. In some embodiments, the docking station may be operable in multiple modes (e.g., configurations), such as a first mode and a second mode. When operating in the first mode, the docking station may obtain data via a docking interface. The docking interface may be configured to couple the docking station to an external computing device such as a laptop, notebook, or tablet. When operating in the second mode, the docking station may obtain data via a network interface, instead of the docking interface. The network interface may be configured to communicate (wired or wirelessly) with a network such as a local area network (LAN), wide area network (WAN), the Internet, or a cloud network. Further, the docking station may output the data obtained via the docking interface or the network interface to a display, depending on whether the docking station operates in the first mode or the second mode.

By enabling docking stations to communicate with a network (such as when operating in the second mode), aspects of the present disclosure may support new features and applications for docking stations even when no external computing devices are coupled thereto. Example suitable applications may include hoteling applications, which are used to manage workspaces (e.g., desks, cubicles, and conference rooms), and/or equipment in the workspaces (e.g., a docking station connected to a network, monitor, keyboard, and mouse). For example, in a hoteling application, a docking station located in an office may (i) receive, via a network, a message indicating that the docking station is reserved for a particular user, and (ii) output the message to a display device. The docking station also may be configured to communicate with a manager or operator of the network, for example, to provide the network manager with information indicating (i) the operational health of the docking station, (ii) the operational health of one or more devices coupled to the docking station, and/or (iii) the environment near the docking station (e.g., the temperature or humidity of the office in which the docking station is located).

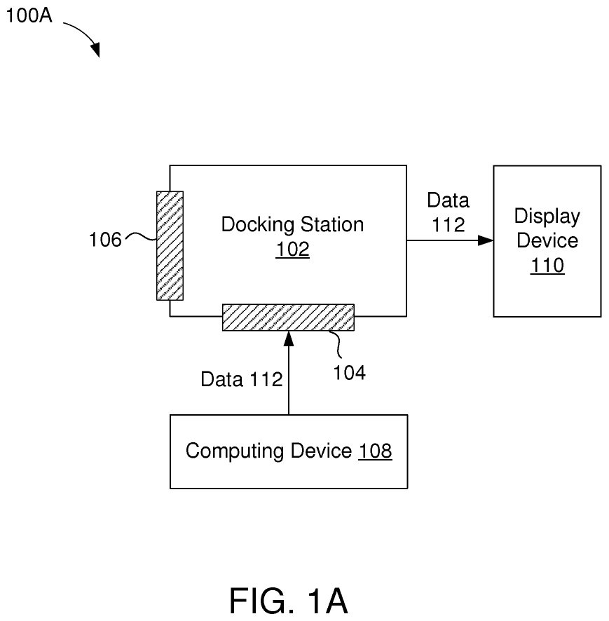

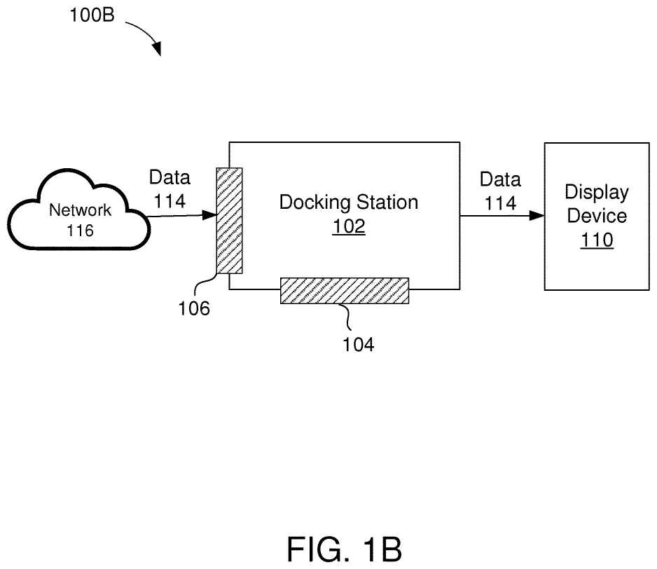

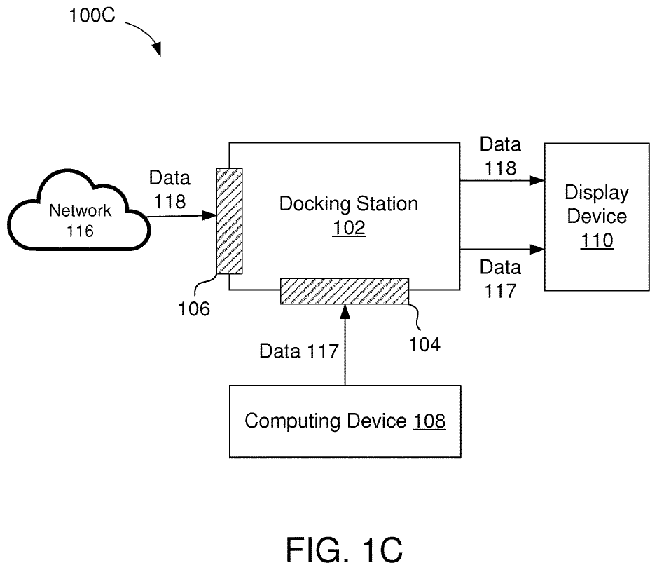

FIG. 1A shows a block diagram depicting an example configuration 100A of a docking station 102, in accordance with some embodiments. More specifically, FIG. 1A shows the docking station 102 in communication with a computing device 108 and a display device 110.

In some embodiments, the display device 110 may be a computer monitor, liquid crystal display (LCD), plasma display, cathode ray tube (CRT) display, light emitting diode (LED) display, organic light emitting diode (OLED) display, or any other type of display or visual interface configured to interface with the docking station 102. Further, the display device 110 may be configured to communicate with and/or receive power from the docking station 102. While one display device 110 is illustrated in FIG. 1A, the docking station 102 can interface to one or more display devices 110.

In some aspects, the docking station 102 may include a docking interface 104 configured to dock (e.g., charge, provide power to, and/or communicate) with one or more electronic devices; and a network interface 106 configured to communicate with a network (not shown in FIG. 1A). The docking interface 104 may be configured to receive or otherwise couple to the computing device 108. In some embodiments, the docking interface 104 may communicate with the computing device 108 via a wired connection (such as USB-C or DisplayPort). In some other embodiments, the docking interface 104 may communicate with the computing device 108 via a wireless communication medium (such as in accordance with Wi-Fi, WiGig, Bluetooth, or various other wireless communication standards). In some embodiments, the computing device 108 may be a laptop, notebook, tablet, or other computing device configured to interface with the docking station 102. Further, the computing device 108 may be configured to communicate with and/or receive power from the docking station 102.

The network interface 106 may be configured to communicate with a network. In some embodiments, the network interface 106 may communicate with a network via a wired connection (such as Ethernet). In some other embodiments, the network interface 106 may communicate with the network via a wireless communication medium (such as in accordance with Wi-Fi or other wireless communication standards). While only two interfaces are shown in FIG. 1A for simplicity, the docking station 102 also includes an interface to receive or otherwise couple to the display device 110. Further, in some embodiments, the docking station 102 may include additional interfaces to receive or otherwise couple to other computing devices and/or peripherals.

As shown in FIG. 1A, when the docking station 102 operates in a first mode, the docking station 102 may obtain data 112 from the computing device 108 via the docking interface 104, and output the data 112 to the display device 110. For example, the data 112 may include text data, image data, and/or video data. In some embodiments, when operating in the first mode, the docking station 102 may output the data 112 to one or more display devices 110, and/or one or more peripherals (e.g., a keyboard, mouse, and/or webcam). Further, in some embodiments, when operating in the first mode, the docking station 102 may not output the data 112 to any display devices 110 and/or peripherals. In some embodiments, when operating in the first mode, the docking station 102 may transmit data from one or more display devices 110 and/or one or more peripherals to the computing device 108.

FIG. 1B shows a block diagram depicting an example configuration 100B of the docking station 102, in accordance with some embodiments. More specifically, FIG. 1B shows the docking station 102 in communication with a network 116 and the display device 110.

The network 116 may include a LAN, WAN, the Internet, a cloud network, private enterprise network, or other network suitable for interfacing with the docking station 102. In some embodiments, the network 116 may communicate with the docking station 102 via a wired connection (such as Ethernet). In some other embodiments, the network 116 may communicate with the docking station 102 via a wireless communication medium (such as in accordance with Wi-Fi or various other wireless communication standards).

As shown in FIG. 1B, when the docking station 102 operates in a second mode, the docking station 102 may obtain data 114 from the network 116 via the network interface 106, and output the data 114 to the display device 110. For example, the data 114 may include text data (e.g., ASCII text), image data (e.g., bitmap data), and/or video data. As another example, in some embodiments, the data 114 may include image data representing a logo and/or two-dimensional barcode (such as Quick Response (QR) code). In some embodiments, when operating in the second mode, the docking station 102 may output the data 114 to one or more display devices 110 and/or one or more peripherals. Further, in some embodiments, when operating in the second mode, the docking station 102 may not output the data 114 to any display devices 110 and/or peripherals. In some embodiments, when operating in the second mode, the docking station 102 may transmit data from one or more display devices 110 and/or one or more peripherals to the network 116.

FIG. 1C shows a block diagram depicting an example configuration 100C of the docking station 102, in accordance with some embodiments. More specifically, FIG. 1C shows that, when operating in a third mode, the docking station 102 may receive data 117 and 118 from the computing device 108 and network 116, respectively, and output the data 117 and 118 to the display device 110. For example, the data 117 and/or 118 may include text data, image data, and/or video data. In some embodiments, when operating in the third mode, the docking station 102 may output the data 117 and/or 118 to one or more display devices 110, and/or one or more peripherals. For example, when operating in the third mode, the data 117 and 118 may be output to the display device 110 for display, where one of the data 117 or 118 is output as On-Screen Display (OSD) data that is overlaid on the other one. For purposes of illustration and not limitation, when one of the data 117 or 118 is OSD data and the other of the data 117 or 118 is video data, the OSD data can be overlaid on the video data to display updated or customized on-screen menus or windows on at least a portion of the display device 110, for instance, to provide a graphical user interface for controlling configuration parameters or other operation of the display device 110. Further, in some embodiments, when operating in the third mode, the docking station 102 may not output the data 117 and/or 118 to any display devices 110 and/or peripherals. In some embodiments, when operating in the third mode, the docking station 102 may transmit data from one or more display devices 110 and/or one or more peripherals to the network 116 and/or the computing device 108. Further, in some embodiments, when operating in the third mode, the docking station 102 may transmit data from the computing device 108 to the network 116.

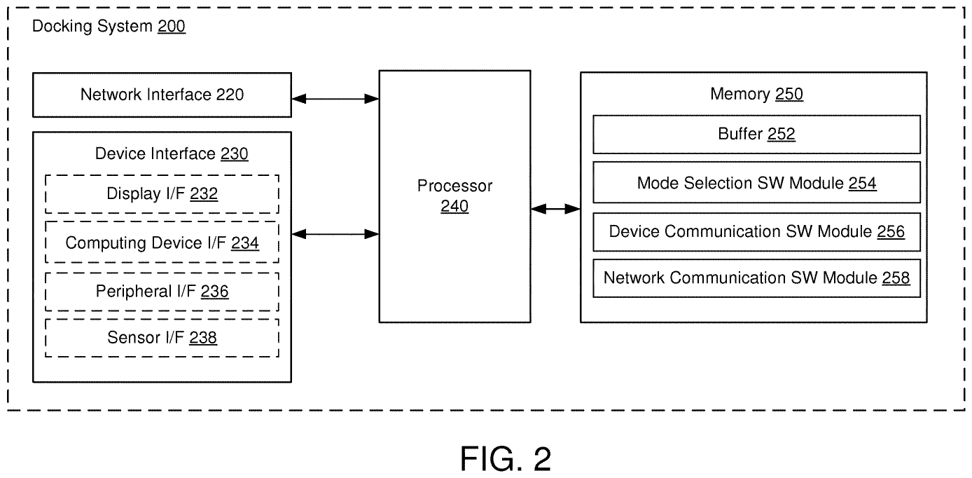

FIG. 2 shows a block diagram of a docking system 200 (also referred to as a “controller 200”), in accordance with some embodiments. The docking system 200 includes a network interface 220, a device interface 230, a processor 240, and a memory 250. For purposes of discussion herein, the processor 240 is shown in FIG. 2 as being coupled to the network interface 220, device interface 230, and memory 250. For actual embodiments, the network interface 220, device interface 230, processor 240, and/or memory 250 may be connected together using one or more buses (not shown for simplicity). It is noted that, in some embodiments, the docking system 200 may be an application specific integrated circuit (ASIC) (e.g., a microcontroller unit (MCU)) or other integrated circuit (IC) disposed on the docking station 102 described with reference to FIGS. 1A-1C. Moreover, in some embodiments, the docking system 200 may be a thin client.

The network interface 220 may transmit and receive signals (wired or wirelessly) to and from a network such as a LAN, WAN, the Internet, a cloud network, private enterprise network, or other network. In some aspects, the network interface 220 may be assigned a media access control (MAC) address to communicate with the network. The device interface 230 may transmit and receive signals to and from devices coupled to the docking system 200. In some embodiments, the device interface 230 may include display interface(s) 232, computing device interface(s) 234, peripheral interface(s) 236, and/or sensor interface(s) 238. The display interface 232 may be used to communicate with a display device and/or to provide a visual interface to a user of the docking system 200. The computing device interface 234 may be used to communicate with a computing device such as a laptop, notebook, or tablet. The peripheral interface 236 may be used to communicate with peripherals such as a mouse, keyboard, webcam, microphone, printer, headphones, speaker, data storage device, or game controller. The sensor interface 238 may be used to communicate with a sensor such as a thermometer, hygrometer, or other device that senses environmental conditions.

The memory 250 may include one or more buffers 252 to store data received from the network interface 220 and/or device interface 230, and to store data (including, for example, text data (e.g., ASCII text), image data (e.g., bitmap data), and/or video data) generated by and/or received from the processor 240. For example, in one embodiment, at least one buffer 252 may be an overlay RAM configured to store OSD data, including, for example, low-resolution text images, such as can be used for on-screen menus and the like. The memory 250 may also include a non-transitory computer-readable medium (e.g., one or more nonvolatile memory elements, such as EPROM, EEPROM, Flash memory, a hard drive, and so on) that may store at least the following software (SW) modules:
a mode (or configuration) selection SW module 254 to selectively switch an operation of the docking system 200 between a first mode, second mode, and third mode, based on the detection of a connection between the docking system 200 and (i) a computing device via the computing device interface 234, and/or (ii) a network via the network interface 220;
a device communication SW module 256 to communicate with and/or facilitate the provision of power to the device interface 230; and
a network communication SW module 258 to communicate with the network interface 220.

Each SW module includes instructions that, when executed by the processor 240, cause the docking system 200 to perform the corresponding functions.

For example, in some embodiments, the processor 240 may execute the mode selection SW module 254 to select the first mode upon detecting that a computing device is docked to the docking system 200 via the computing device interface 234. In executing the mode selection SW module 254 to operate in the first mode, the processor 240 may obtain data from the computing device interface 234 and output the data to the display interface 232. In some embodiments, in executing the mode selection SW module 254 to operate in the first mode, the processor 240 may obtain data from the computing device interface 234 and output some or all of the data to one or more display interfaces 232, one or more peripheral interfaces 236, and/or one or more sensor interfaces 238. Further, in some embodiments, in executing the mode selection SW module 254 to operate in the first mode, the processor 240 may transmit data from one or more display interfaces 232, one or more peripheral interfaces 236, and/or one or more sensor interfaces 238, to the computing device interface 234.

As another example, in some embodiments, the processor 240 may execute the mode selection SW module 254 to select the second mode upon detecting that the docking system 200 is connected to a network via the network interface 220, but not connected to a computing device via the computing device interface 234. In executing the mode selection SW module 254 to operate in the second mode, the processor 240 may obtain data from the network interface 220 and output the data to the display interface 232. In some embodiments, in executing the mode selection SW module 254 to operate in the second mode, the processor 240 may obtain data from the network interface 220 and output some or all of the data to one or more display interfaces 232, one or more peripheral interfaces 236, and/or one or more sensor interfaces 238. Further, in some embodiments, in executing the mode selection SW module 254 to operate in the second mode, the processor 240 may transmit data from one or more display interfaces 232, one or more peripheral interfaces 236, and/or one or more sensor interfaces 238, to the network interface 220.

As another example, in some embodiments, the processor 240 may execute the mode selection SW module 254 to select a third mode upon detecting that the docking system 200 is connected to both (i) a computing device via the computing device interface 234, and (ii) a network via the network interface 220. In executing the mode selection SW module 254 to operate in the third mode, the processor 240 may obtain data from the computing device interface 234 and network interface 220 and output these data to the display interface 232. In some embodiments, in executing the mode selection SW module 254 to operate in the third mode, the processor 240 may obtain data from the computing device interface 234 and network interface 220, and output some or all of these data to one or more display interfaces 232, one or more peripheral interfaces 236, and/or one or more sensor interfaces 238. Further, in some embodiments, in executing the mode selection SW module 254 to operate in the third mode, the processor 240 may transmit data from one or more display interfaces 232, one or more peripheral interfaces 236, and/or one or more sensor interfaces 238, to the computing device interface 234 and/or network interface 220. Additionally, in some embodiments, in executing the mode selection SW module 254 to operate in the third mode, the processor 240 may transmit data between the network interface 220 and the computing device interface 234.

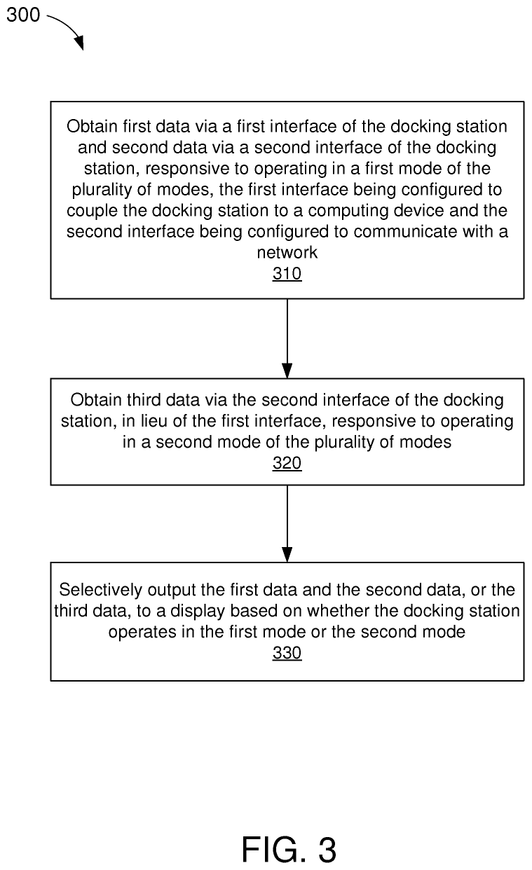

FIG. 3 shows an illustrative flowchart depicting an example method 300 performed by a docking station, in accordance with some embodiments. The method 300 may be performed by the docking station 102 of FIGS. 1A-1C or the docking system 200 of FIG. 2.

As an illustrative example, the method 300 may be performed by the docking station 102 of FIGS. 1A-1C, which is operable in a plurality of modes (e.g., configurations). The method 300 may include obtaining first data via a first interface of the docking station 102 and second data via a second interface of the docking station 102, responsive to operating in a first mode of the plurality of modes (310). It is noted that this first mode of the plurality of modes corresponds to the third mode depicted in FIG. 1C. The first interface may be configured to couple the docking station 102 to a computing device, and the second interface may be configured to communicate with a network.

The method 300 may also include obtaining third data via the second interface of the docking station 102, in lieu of (or as an alternative to) the first interface, responsive to operating in a second mode of the plurality of modes (320).

The method 300 may also include selectively outputting the first data and the second data, or the third data, to a display based on whether the docking station 102 operates in the first mode or the second mode (330).

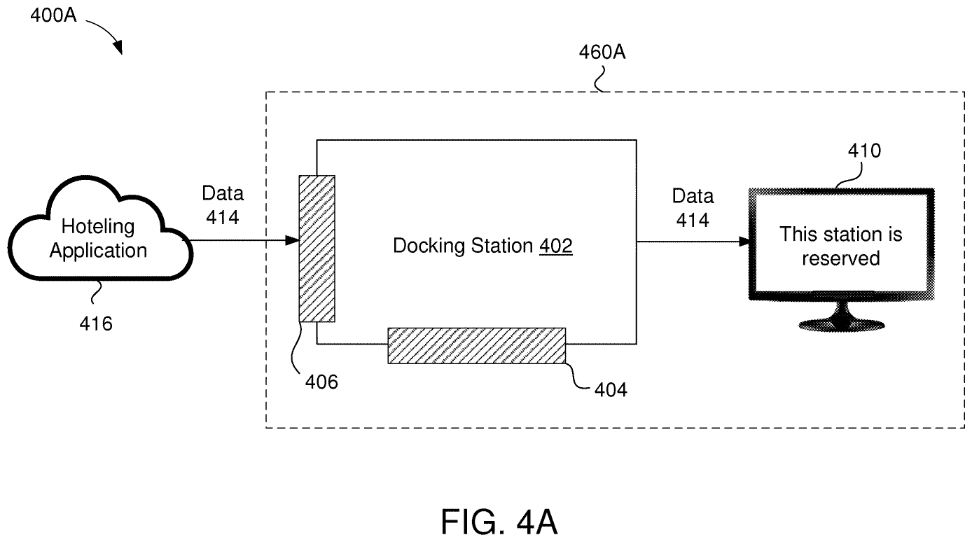

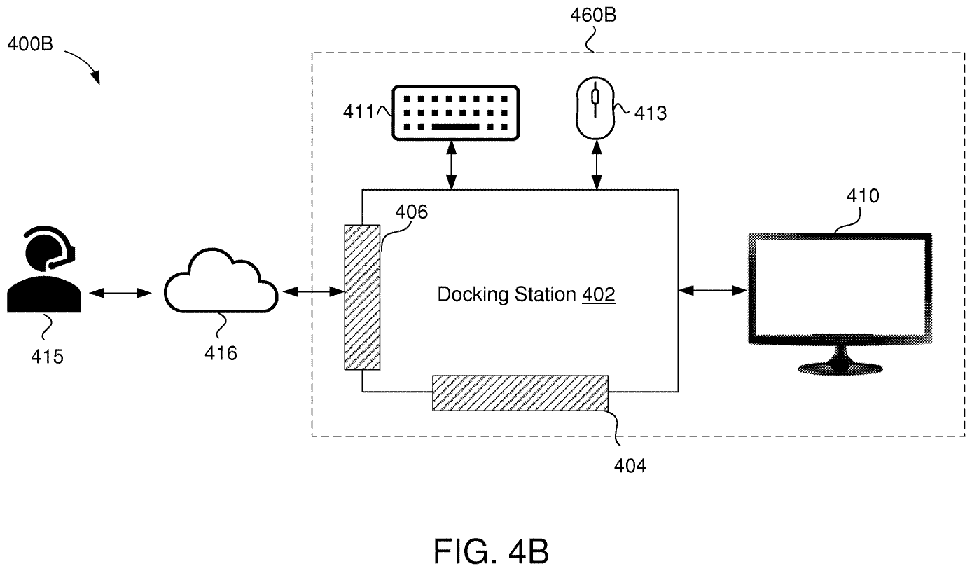

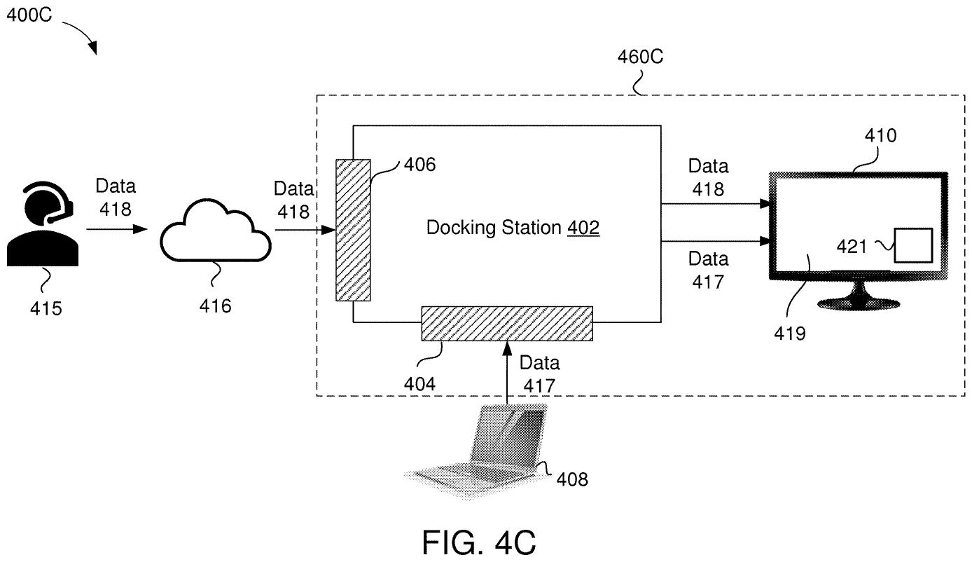

FIG. 4A shows an example application 400A of a docking station 402 operating in a second mode, in accordance with some embodiments. The docking station 402 may be an embodiment of the docking station 102 of FIGS. 1A-1C or the docking system 200 of FIG. 2. As shown in FIG. 4A, the application 400A involves a network 416 and the station 460A, which includes the docking station 402 and a monitor 410. The network 416 and monitor 410 may be embodiments of the network 116 and display device 110, respectively, of FIG. 1B.

As an illustrative example, Company X may have an office that includes multiple stations, such as the station 460A, which provides a desktop computing environment for Company X's employees to use. In some embodiments, the station 460A may include additional monitors 410 and/or one or more peripherals. Company X's employees may have a flexible work schedule that allows them to work at the office two days per week and work from home three days per week. Prior to going to the office, each of Company X's employees may use a hoteling application to reserve a particular station at the office for use during one or more periods of time.

One Monday evening, from home, Company X's employee, Employee Y, may use their company-issued laptop to access the hoteling application in network 416. Employee Y may use the hoteling application to reserve the station 460A for the next two days (Tuesday and Wednesday), when Employee Y plans to work at the office. In some embodiments, the hoteling application may notify Company X's cleaning team of the reservation, and the cleaning team may subsequently clean the station 460A.

Further, in some embodiments, the docking station 402 may obtain data 414 from the hoteling application in the network 416 via a network interface 406. The data 414 may include information associated the Employee Y's reservation, such as the employee's name, the particular station reserved, the date and time of the reservation, and/or the status of the reservation (e.g., whether the reservation is active or canceled). The docking station 402 may then output some or all of data 414 to the monitor 410 for display. For example, as shown in FIG. 4A, the monitor 410 may display the message, “This station is reserved,” to notify individuals (other than Employee Y) who walk by the station 460A early Tuesday morning, for example, that the station 460A is reserved and not available for use. In some embodiments, the message displayed may further communicate to such individuals that they should not approach and/or touch the station 460A in order to maintain the cleanliness of the station 460A. Further, in some embodiments, the message may continue to be displayed until Employee Y arrives at the office and couples their company-issued laptop with the station 460A. The message may also be displayed when Employee Y steps away from the station 460A during the reserved time period(s).

Accordingly, the docking station 402 provides a number of advantages. Because the docking station 402 communicates with the network 416, the docking station 402 supports the hoteling application by obtaining and outputting the message concerning the reservation to the monitor 410. Moreover, because the docking station 402 outputs the message concerning the reservation to the monitor 410 for display, the docking station 402 communicates information that may help keep station 460A clean and safe for Employee Y to use, which is especially important, for example, during a pandemic. Further, while some existing hoteling solutions require non-standard, special-purpose hardware, the docking station 402 obviates the need for such hardware.

While not shown in FIG. 4A, in some embodiments, the docking station 402 may include one or more LEDs and/or displays configured to communicate information associated with the docking station 402. For example, the information may relate to a reservation of the station 460A, the operational health of (e.g., diagnostic information associated with) the docking station 402, or information obtained from sensors or peripherals coupled to the docking station 402. Moreover, in some embodiments, when the station 460A is available for a reservation (e.g., not in use or out of service), the docking station 402 may output a message to the monitor 410 for display, indicating that the station 460A is available for reservation.

FIG. 4B shows an example application 400B of the docking station 402 operating in the second mode, in accordance with some embodiments. As shown in FIG. 4B, the application 400B involves an IT professional 415, the network 416, and a station 460B, which includes the docking station 402, the monitor 410, a keyboard 411, and a mouse 413. The station 460B may be an embodiment of the station 460A of FIG. 4A.

Continuing with the example of FIG. 4A, Monday evening, after Employee Y reserves the station 460A of FIG. 4A (or station 460B of FIG. 4B), the IT professional 415 (who works for Company X) may communicate, via the network 416, with docking station 402 to determine the operational health of (i) the docking station 402 and/or (ii) one or more devices coupled to the docking station 402. In some embodiments, the docking station 402 may communicate with the keyboard 411, mouse 413, and/or monitor 410 to determine the operational health of one or more of these devices. The docking station 402 may determine, for example, that each of the keyboard 411, mouse 413, and monitor 410 is powered on, and that the mouse 413 needs a firmware update. The docking station 402 may subsequently communicate this determination to the IT professional 415 via the network 416. In some embodiments, the IT professional 415 may then facilitate remotely, via the network 416 and docking station 402, the transfer and installation of the firmware update to the mouse 413. Accordingly, when the docking station 402 operates in the second mode, the docking station 402 may support remote monitoring and maintenance of the docking station 402 and devices coupled to the docking station 402.

While not shown in FIG. 4B, in some embodiments, the docking station 402 may be coupled to one or more sensors such as a thermometer and/or hygrometer used to sense environmental conditions near the docking station 402. In some embodiments, the docking station 402 may be configured to transmit information from these sensors to the IT professional 415 via the network 416. Moreover, in some embodiments, when the station 460B is not available for reservation due to, for example, a technical issue with the docking station 402 or one or more peripherals coupled to the docking station 402, the docking station 402 may output a message to the monitor 410 for display, indicating that the station 460B is out of service and not available for reservation.

FIG. 4C shows an example application 400C of the docking station 402 operating in a third mode, in accordance with some embodiments. As shown in FIG. 4C, the application 400C involves the IT professional 415, the network 416, a laptop 408, and a station 460C, which includes the docking station 402, and the monitor 410. The station 460C may be an embodiment of the station 460A or 460B in FIGS. 4A and 4B, respectively. The laptop 408 may be an embodiment of the computing device 108 in FIGS. 1A and 1C. In some embodiments, the station 460C may include additional devices, such as a second monitor 410, keyboard, and mouse.

Continuing with the example of FIGS. 4A and 4B, on Tuesday morning, Employee Y may arrive at the office and walk to station 460A of FIG. 4A (or station 460C of FIG. 4C), where Employee Y plans to work. While at the station 460C, Employee Y may dock Employee Y's company-issued laptop 408 with the docking station 402 via a docking interface 404. The docking station 402 may then obtain data 417 (e.g., text data, image data, and/or video data) from the laptop 408 and output the data 417 to the monitor 410 for display in window 419.

While Employee Y works at the station 460C, the IT professional 415 may communicate with the docking station 402, via the network 416, to determine the operational health of the laptop 408. The docking station 402 may then communicate with the laptop 408 and determine that the laptop 408 needs a software update. In some embodiments, the docking station 402 may then communicate this determination to the IT professional 415. Further, in some embodiments, the docking station 402 may obtain, from the IT professional 415, data 418 via the network 416. The data 418 may include information directed to Employee Y concerning the software update, such as a request for Employee Y to specify a time for the software update to be installed. The docking station 402 may then output some or all of data 418, including the request, to the monitor 410 for display in window 421. In some embodiments, the window 421 may be overlaid on the window 419 with data 417 displayed on the monitor 410. Employee Y may then view some or all of data 418, including the request, in window 421.

In some embodiments, Employee Y may respond to the request by, for example, using the laptop 408 to send a message to the IT professional 415 (via the docking station 402 and network 416), indicating that Employee Y would like for the software update to be installed on the laptop 408 later that day at 4 PM. At 4 PM, the IT professional 415 may facilitate remotely, via the network 416 and docking station 402, the transfer and installation of the software update to the laptop 408. Accordingly, when the docking station 402 operates in the third mode, the docking station 402 permits the IT professional 415 to monitor and/or maintain the operational health of Employee Y's laptop 408, and to communicate with Employee Y.

In some implementations, the data 418 received from an external computing device or processor through the network 416 via the network interface 406 may include, e.g., text data, image data, and/or video data, and is overlaid on the data 417 and output to the monitor 410 to be displayed when the docking station 402 is operating in the third mode as discussed in reference to FIGS. 1C and 4C. Moreover, in some implementations, the data that is overlaid on the data 417 and output to the monitor 410 when operating in the third mode may be received by the docking station 402 from sources other than the network 416. For example, the data that is overlaid on the data 417 and that is output to and displayed by the monitor 410, may originate from sources such as a processor associated with the docking station 402 (e.g., an internal processor or an external processor), a microcontroller associated with the docking station 402 (e.g., an internal microcontroller or an external microcontroller), memory associated with the docking station 402 (e.g., internal memory or external memory), a second computing device that differs from the laptop 408, the monitor 410 itself, a peripheral device, etc.

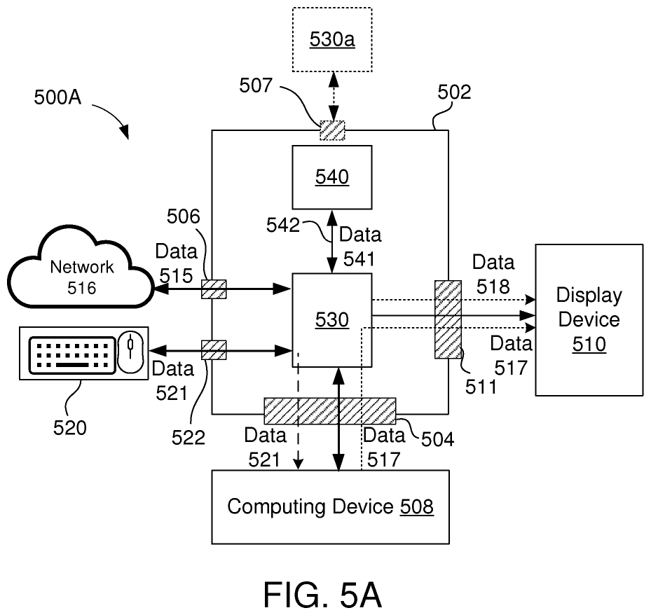

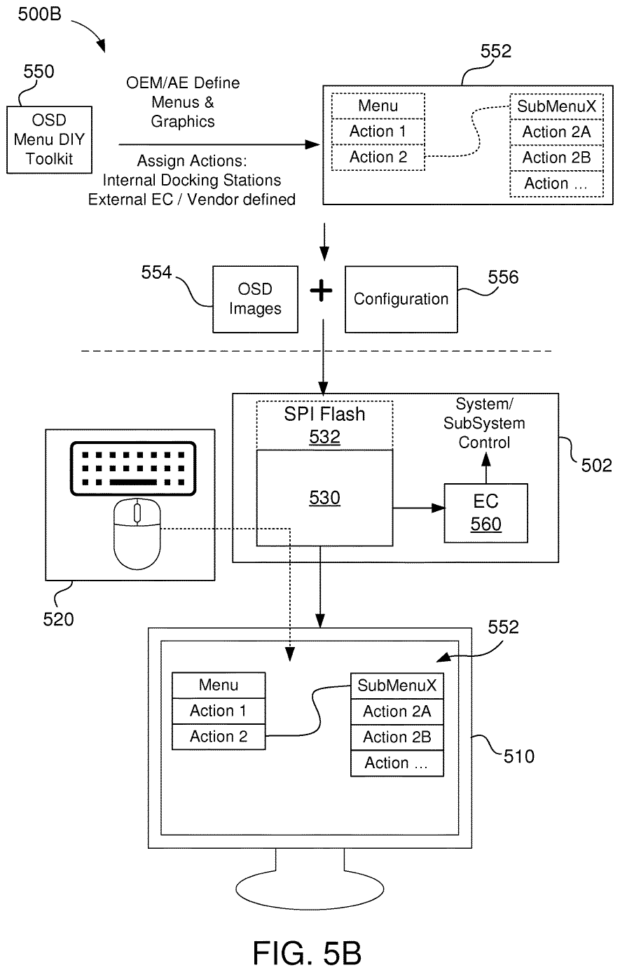

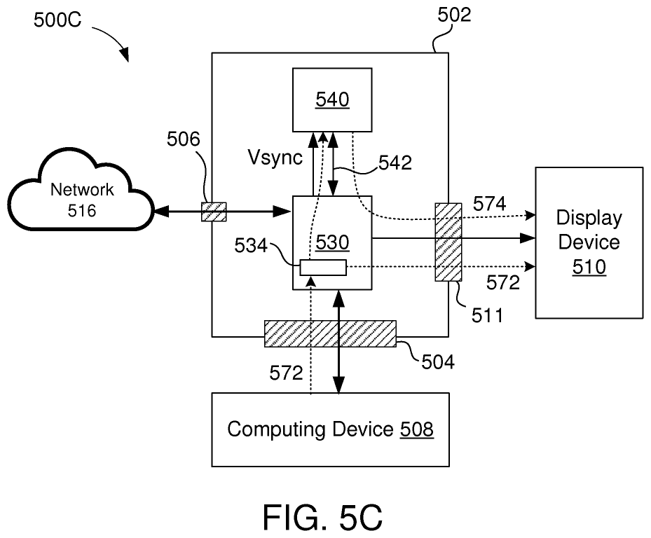

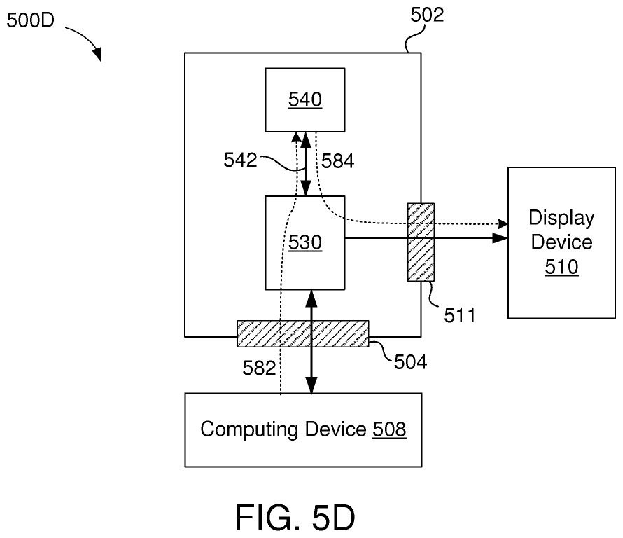

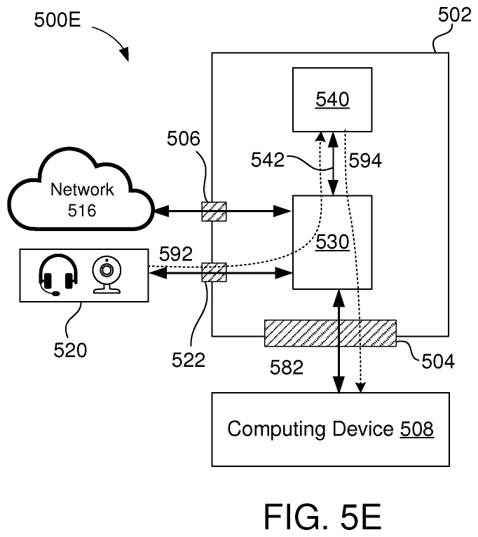

FIG. 5A shows an example application 500A of a docking station 502 operating to receive first data from a computing device 508 and second data from one or more different sources, and to output the first data and the second data to a display device 510 for display, in accordance with some embodiments. The docking station 502 may be an embodiment of the docking station 102 of FIGS. 1A-1C, the docking system 200 of FIG. 2, or the docking station 402 of FIGS. 4A-4C. As shown in FIG. 5A, the application 500A involves the docking station 502, a computing device 508, and the display device 510, and further involves one or more of a network 516; one or more peripherals 520, such as a mouse, keyboard, webcam, microphone, printer, headphones, speaker, data storage device, game controller, etc.; a processor 530 associated with the docking station 502, and a second processor 540 that may be internal to the docking station 502 (as illustrated in FIG. 5A) or may be external to the docking station. The processor 530 associated with the docking station 502, for example, may control operations of the docking station 502 as discussed herein, and may be internal to the docking station 502, or may be external to and coupled to the docking station 502 via an interface 507, as illustrated by processor 530a with dotted lines. The second processor 540 may be, e.g., an artificial intelligence (AI) processor, a system-on-chip (SOC) processor, or any other desired type of processor that may control various applications or functions of the docking station 502. In some implementations, the second processor 540 may be an external second host computing device and the docking station 502 is driven by two host computing devices, e.g., in a KVM (Keyboard, Video, and Mouse) architecture. The network 516 and display device 510 may be embodiments of the network 116 and display device 110, respectively, of FIG. 1B or the network 416 and monitor 410, respectively, of FIG. 4C, while the peripherals 520 may be embodiments of the keyboard 411 and mouse 413 of FIG. 4B.

In some aspects, the docking station 502 may be configured to receive data 517 from the computing device 508 via a docking interface 504, where the data may include, e.g., text data, image data, and/or video data. The docking interface 504, for example, may be an embodiment of the docking interface 104 or 404 of FIG. 1A or 4C, respectively. The docking station 502 may output to the display device 510 via a display interface 511, at least a portion of the data 517 that is displayed by the display device 510. The display interface 511, for example, may be, e.g., HDMI, DisplayPort, USB-C, or any other appropriate interface. In some implementations, the data 517 from the computing device 508 may be received by the internal processor 530 and provided to the display device 510 via processor 530.

The docking station 502 may be further configured to receive data 515, which may include, e.g., text data, image data, and/or video data, from the network 516 via a network interface 506 that is configured to communicate with the network 516. The network interface 506, for example, may be an embodiment of the network interface 106 or 406 of FIG. 1B or 4C, respectively. The docking station 502 may be further configured to receive data 521, which may include, e.g., text data, image data, and/or video data, from the one or more peripherals 520 via a peripheral interface 522 that is configured to communicate with the one or more peripherals 520. The peripheral interface 522, for example, may be one or more Universal Serial Bus (USB) ports or other appropriate interface. The docking station 502 may be further configured to receive data 541, which may include, e.g., text data, image data, and/or video data, from the processor 540 via an interface 542, which may include one or more of a USB port, DisplayPort, PCIe, SPI, Ethernet, CAPI, or other appropriate interface. In some implementations, the docking station 502 may be further configured to receive data, including text data, image data, and/or video data, from the display device 510 via the display interface 511.

Any one of data 515, 521, 541, or data from the display device 510 may be provided to the processor 530. The processor 530 may be configured to output data 518 to the display device 510 for display of the data 518 via the display interface 511. The data 518 may include at least a portion of any of one or more of data 515, 521, 541, data from the display device 510, or data from an internal memory in the docking station 502. The data 518 may include any of text data, image data, and/or video data. The data 518 may not be sourced from the computing device 508, and accordingly, in some implementations, the data 518 may be generated and output to the display device 510 even when the computing device 508 is not connected to the docking station 502. In some implementations, when the computing device 508 is connected to the docking station 502, the data 518 may be displayed on the display device 510 along with the data 517 from the computing device 508. For example, the data 518 may be overlaid on the data 517. In some implementations, one or both of the data 518 and 517 may be video data.

In some implementations, any of the data 515, 521, 541, data from the display device 510, or data from internal memory in the docking station 502, may be on-screen display (OSD) data, which may be used to generate data 518 that is an on-screen display menu, such as a graphical menu or text, that is displayed by the display device 510. The on-screen display menu may be overlaid on data 517 from the computing device 508 and provided to the display device 510 to display. The on-screen display menu, for example, may offer system and/or application configuration options, allowing a user to adjust settings such as brightness, contrast, input sources, volume, or any other parameter or setting, or otherwise control and/or assign video, audio, data, or network, or to control applications. In some embodiments, the on-screen display menu can provide updated or customized on-screen menus to replace, supplement, modify, or augment existing (e.g., pre-installed, fixed-function) on-screen menus displayed on the display device 510 or provide on-screen menu functionality when no such functionality exists in or is otherwise provided with the display device 510. For example, the data 518 may be an on-screen display menu for the display device 510, one or more peripherals 520, or any desired component or sub-component of the docking station 502. The on-screen display menu can be displayed in all or any portion of the display device 510.

In some implementations, the docking station 502 may intercept Human Interface Device (HID) commands from the one or more peripherals 520, e.g., from a mouse and keyboard, for use with the on-screen display menu. For example, the processor 530 may receive the HID commands from the data 521 from the one or more peripherals 520 and use the HID commands to control, navigate, and select options on the on-screen display menu. The HID commands or a hotkey, for example, may be used to initiate an on-screen display mode, in which the on-screen display menu data 518 is generated and output for display on the display device 510. In this mode of operation, the HID commands are not sent to the computing device 508, but are intercepted by the docking station 502 and used by the processor 530 to control, navigate, and select from the on-screen menu that is displayed by the display device 510. Based on the selection of the on-screen display menu, the processor 530 may provide selection data to the appropriate component, e.g., the display device 510, the one or more peripherals 520, or a system of the docking station 502, to configure the component in response. Once the on-screen display menu selection is complete, e.g., when the HID commands or the hotkey indicate exit from the on-screen display mode, the docking station 502 may resume sending the HID commands from data 521 to the computing device 508, e.g., as illustrated by the dashed arrow.

In contrast, in conventional on-screen display operations, e.g., for a monitor, one or more buttons or a joystick on the back or bottom of the monitor itself is used. The on-screen display menu may be displayed by the monitor and navigation and selections are made in response to user manipulation of the buttons or joystick on the monitor itself. Thus, conventionally, manipulating the on-screen display menu requires the user to access the buttons or joystick on the back or bottom of the monitor, which may be difficult to locate and manipulate, particularly as their location and operation are typically unfamiliar to the user. Accordingly, conventional on-screen display operations tend to be tedious, frustrating, and physically tiring for a user to perform for any length of time.

With the processor 530 providing on-screen display menu data 518 to the display device 510, and intercepting and interpreting the HID commands from data 521 for menu navigation and selections while in on-screen display menu mode, the user may interact with the on-screen display menu in a natural and comfortable manner. Embodiments of the present disclosure also allow the on-screen display menus to be more easily updated or customized to replace, supplement, modify, or augment existing (e.g., pre-installed) on-screen menus displayed on the display device 510 or provide on-screen display menu functionality when such functionality does not natively exist in the display device 510.

FIG. 5B shows an example application 500B for the docking station 502 of FIG. 5A to operate with an on-screen display framework for dynamic system configuration via communication with an embedded controller 560 in the docking station 502, in accordance with some embodiments. In some implementations, the embedded controller 560 may be an implementation of the processor 540 shown in FIG. 5A, and in other implementations, the embedded controller 560 may be used in addition to the processor 540. As shown in FIG. 5B, the application 500B may involve the docking station 502, the display device 510, and an on-screen display (OSD) menu Application Programming Interface (API) 550 (sometimes referred to as a DIY toolkit), which allows original equipment manufacturers (OEMs) or aftermarket equipment manufacturers (AEs) or the like to define the on-screen display menu and actions.

As illustrated in FIG. 5B, the OSD menu API 550 may be used by entities, such as OEMs and AEs, to define on-screen display menus and graphics 552, and to configure corresponding actions. The on-screen display menus and graphics 552, for example, may be defined based on the menu hierarchy, including main menu and submenus, as well as graphics and layouts. For purposes of illustration and not limitation, the OSD menu API 550 may be used to define the menu item actions, such as fan profiles, LED behavior, mux selection, power domains, etc., for systems of the docking station 502. Additionally or alternatively, the OSD menu API 550 may be used to define menu item actions for other systems or sub-systems connected to the docking station 502, such as brightness, input selection, resolution, etc., for the display device 510. The actions may be assigned to the processor 530 or an embedded controller 560, which may be internal or external to the docking station 502. The actions may be vendor-defined, e.g., using vendor-defined run-control (RC) codes, which may be provided by an RC protocol specification. The resulting OSD images 554, e.g., the on-screen display menus and graphics, and the resulting configuration 556, e.g., the assigned actions, may be provided to the docking station 502. In one implementation, for example, the OSD images 554 and configuration 556 may be loaded into the processor 530 of the docking station 502 via SPI flash 532 or other appropriate storage device, which stores the OSD image assets and the configuration metadata, such as menus and RC actions. In some implementations, the SPI flash 532 may operate as an internal memory of the docking station 502 that provides data, e.g., the OSD images 554, to be displayed on the display device 510. In some implementations, the on-screen display menus and graphics and configuration 556 may be stored on and provided by the embedded controller 560.

The processor 530 may enter an on-screen display mode in response to HID commands or a hotkey, and provide the on-screen display menu data 518, e.g., including the on-screen display menus and graphics 552, to the display device 510 for display. The on-screen display menus and graphics 552 may be navigated and selected by a user via one or more peripherals 520, such as a mouse and/or keyboard, e.g., with the docking station 502 intercepting the HID commands. The processor 530, for example, may parse the configuration logic as selected via the HID commands from the user interface.

The on-screen display mode may be used as a full system configuration interface, e.g., supporting context-driven menus navigable via mouse or keyboard, to allow users to adjust system-level settings, as well as sub-system settings, which may not be handled by the processor 530 alone. For example, as illustrated, the processor 530 may communicate with the embedded controller 560, which may be internal or external to the docking station 502. The processor 530 may provide run-control (RC) protocol-driven communications to the embedded controller 560 in response to user selection to enable desired configuration outcomes depending on the system or sub-system to be controlled, such as fan speed, LED behavior, mux selection, etc., of the docking station 502. The communication between the processor 530 and the embedded controller 560, for example, may be via I²C or USB, or other appropriate interface. The processor 530, thus, may present configuration options to a user via the on-screen display menus and graphics 552, which may be sourced from the SPI flash 532 or the embedded controller 560, and may send configuration outcomes back to the embedded controller 560. The embedded controller 560 may interpret the vendor-defined action identifiers, e.g., provided in the run-control (RC) protocol-driven communications from the processor 530, and may execute corresponding control of the desired system or sub-system behavior, such as fan, LEDs, General-Purpose Input/Output (GPIO), power connections, port multiplexing, etc. of the docking station 502, or of components external to the docking station 502.

The framework of application 500B enables an on-screen display mode, driven by the processor 530, to serve as a comprehensive configuration interface for the entire ecosystem of the docking station 502, including systems or subsystems that may be controlled by the embedded controller 560, to provide a centralized, user-friendly control of the docking station 502 and system and sub-system-level behavior without requiring software or driver installation on a host computing device. With the framework of application 500B, a unified configuration interface is provided across processor 530 and embedded controller 560 control domains, with no host software requirement. The menus and actions are modular and vendor-extensible, and the embedded controller 560 may define its own action set. Moreover, customization of, e.g., graphics and menu logic, is possible through the OSD menu API 550, and the end-user experience is enhanced by providing user-friendly control for setup, tuning, and diagnostics of systems and sub-systems in the ecosystem of the docking station 502.

In contrast, conventional on-screen display configuration for systems and sub-systems connected to the docking stations, as well as the docking stations themselves, is typically fixed-function and disconnected from external embedded controllers. Accordingly, conventional configuration for systems and sub-systems of a docking station, such as fan, LEDs, multiplexing, or power domains, as well as systems and sub-systems connected to the docking station, is typically performed through fixed-function vendor software or firmware presets, and is not available as a runtime user interface. Without a centralized, interactive dock user interface, conventional systems do not permit users to configure system-or sub-system-level functions, such as thermal or power profiles or other appropriate configuration settings of devices within the docking station ecosystem, without external software.

FIG. 5C shows an example application 500C of the docking station 502 operating to overlay video, e.g., picture-in-picture (PIP), from different sources without use of a frame buffer, in accordance with some embodiments. As shown in FIG. 5C, the application 500C involves at least a docking station 502 and the display device 510, a source of first video data 572, such as the computing device 508, and the processor 540 acting as the source of second video data 574. In some implementations, the first video data and/or the second video data may be sourced from other entities, such as a processor connected via the network 516.

As illustrated in FIG. 5C, the computing device 508 provides the video data 572 to the docking station 502 via the docking interface 504. The processor 530 may receive the video data 572 and extract a vertical synchronization (Vsync) signal from the video data 572, e.g., with a Vsync extractor module 534. In some implementations, the processor 530 may provide the Vsync signal to the second processor 540, which may be an AI SoC or the like, via a Vsync interface. In some implementations, the processor 530 may additionally provide the remainder of the video data 572 via interface 542. In some implementations, the Vsync signal may be provided via the interface 542. The second processor 540 may be configured to generate the second video data 574 based on the Vsync signal. For example, the second processor 540 may adjust the second video data 574 to match the Vsync signal. The resulting second video data 574 produced by the second processor 540 and provided to processor 530, thus, will have the same vertical synchronization as the first video data 572 from the computing device 508. With video images from both video data 572 and 574 having the same vertical synchronization, the processor 530 may overlay the second video data 574 on top of the first video data from the computing device 508 in any desired location, e.g., as PiP video data.

Conventional systems that overlay video typically require an external frame buffer. In contrast, with application 500C, the docking station 502 may overlay video generated by the second processor 540 on the video from the computing device 508, without requiring an external frame buffer. Accordingly, multiple video images may be displayed by a single monitor in a cost-effective manner.

FIG. 5D shows an example application 500D of the docking station 502 operating to provide video path interception via a processor associated with the docking station 502 for real-time video processing and enhancement, in accordance with some embodiments. As shown in FIG. 5D, the application 500D may involve at least the docking station 502, the computing device 508, and the display device 510.

Application 500D enables a processor associated with the docking station 502, e.g., the second processor 540, to act simultaneously as, for example, a DisplayPort sink (with respect to the computing device 508) and a DisplayPort source (with respect to the display device 510), although the use of other suitable high-performance digital video connection protocols is possible. The second processor 540 receives video data from the host computing device 508, modifies the video data in real-time or near real-time, and outputs the modified video data that is provided to the display device 510. In some implementations, the video data may be received from another computing device or processor, e.g., through the network 516 via the network interface 506 (shown in FIG. 5A or 5C) or from one or more peripheral devices 520, e.g., a video camera, via peripheral interface 522. The second processor 540, for example, may be an AI processor, or other type of processor configured to provide AI video services. The architecture of the docking station 502 enables the second processor 540 to perform real-time video processing, including eye-tracking overlays, eye contact correction, attention tracking, noise or artifact removal, filtering, bandwidth-aware video optimization (e.g., compression or resolution scaling), real-time annotation or overlay rendering, video watermarking or branding, privacy masking or redaction, monitoring or capture of analytics/logging, or other desired enhancements, without the host computing device 508 or the display device 510 being aware of any intervention. In some implementations, the application 500D is achieved by integrating, for example, both DisplayPort receiver (DP Rx) and transmitter (DP Tx) IP cores into the second processor 540, which enables full interception and manipulation of DisplayPort video streams. Thus, the application 500D enables deployment of AI video services across existing hardware and expands use cases for AI video services beyond USB-class devices into high-bandwidth video applications.

In contrast, conventional systems typically pass DisplayPort signals directly from the host computing device to the display device, with no inline modification unless built into the display or host driver stack.

As illustrated, the computing device 508 may provide video data 582 that is received by the docking station 502 and is passed through to the second processor 540, e.g., via the processor 530. The second processor 540, which may be an AI SoC or the like, is configured to receive the incoming video data 582 via interface 542. The second processor 540, for example, may include an integrated DP Rx IP core coupled to one or more DisplayPort lanes for deserializing, decoding, performing link training, extracting main-stream attributes, and converting the serial packetized data into parallel video and timing signals for internal processing. The second processor 540 may include a processor core logic, such as an internal AI engine, that processes the video frame stream, e.g., for functions such as real-time annotation or overlay, e.g., for telepresence enhancements, video watermarking or branding, privacy masking or redaction, monitoring or capturing analytics/logging, etc. The second processor 540 may further include a DP Tx IP core that receives the processed video data 584 from the processor core logic, packs pixels into multiple lanes, encodes the stream in accordance with the DisplayPort protocol, and provides the processed video data 584 to the display device 510 via the display interface 511, e.g., through the processor 530. The second processor 540 may emulate the display Extended Display Identification Data (EDID) and manage link training so that the host computing device 508 believes that it is connected directly to the display device 510. Accordingly, the second processor 540 and its inline modification of the video data are transparent to both the host computing device 508 and the display device 510 because the display EDID is emulated by the second processor 540.

FIG. 5E shows an example application 500E of the docking station 502 operating to provide peripheral or network data interception via a processor associated with the docking station 502 for real-time processing and enhancement, in accordance with some embodiments. As shown in FIG. 5E, the application 500E may involve the docking station 502, the computing device 508, the network 516, and the one or more peripheral devices 520.

Application 500E enables a processor associated with the docking station 502, e.g., the second processor 540, to be seamlessly inserted as a transparent man-in-the-middle (MitM) between the host computing device 508 and the one or more peripheral devices 520, illustrated in FIG. 5E as, for example, a headset and camera. The second processor 540 may be an AI processor, or other type of processor, configured to intercept data 592 from the one or more peripheral devices 520, e.g., for real-time enhancement, filtering, or protocol conversion. The second processor 540, for example, may support multiple USB device classes, such as audio, video, HID, storage, etc., and may be configured for security (e.g., filtering), productivity (e.g., real-time noise reduction), data compression, or other real-time enhancement, filtering, or protocol conversion, which may be easily integrated into the system architecture without requiring driver changes. The second processor 540 may be further configured to support runtime switching or filtering policies. In some implementations, the second processor 540 may be additionally or alternatively inserted as a transparent MitM between the host computing device 508 and the network 516. In some implementations, the second processor 540 may be an external second host computing device that operates as a MitM between the one or more peripheral devices 520 and the host computing device 508.

The processor 530 is configured to facilitate the transfer of data 592 from the one or more peripheral devices 520 to the second processor 540 and the transfer of modified data 594 from the second processor 540 to the host computing device 508. Thus, the second processor 540 operates as a USB host with respect to the downstream peripheral devices 520 (or network 516) and operates as a USB device with respect to the upstream host computing device 508. With this architecture, the second processor 540 may intercept, analyze, and optionally manipulate data traffic from the one or more peripheral devices 520, e.g., applying artificial intelligence or other advanced processing, to produce modified data 594 before forwarding the data traffic upstream to the host computing device 508. The host computing device 508 perceives no change in connectivity of the one or more peripheral devices 520, as the second processor 540 emulates the peripherals while managing real-time data routing and processing, e.g., using software drivers.

In contrast, standard USB docking stations typically serve as passive bridges and are not capable of intelligent data path interception or modification. Accordingly, standard USB docking stations are not capable of inline processing of the USB data streams.

Those of skill in the art will appreciate that information and signals may be represented using a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences, or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method, comprising:
obtaining, by a docking station when operating in a first mode of a plurality of modes, first data via a first interface of the docking station, the first interface being configured to couple the docking station to a computing device;
obtaining, by the docking station when operating in a second mode of the plurality of modes, second data via a second interface of the docking station; and
selectively outputting, to a display via a third interface of the docking station that is different from the first interface and the second interface, the first data in response to the docking station operating in the first mode, or the second data in response to the docking station operating in the second mode, or the second data overlaid on at least a portion of the first data in response to the docking station operating in a third mode, wherein the selectively outputting further comprises determining that the computing device is not coupled to the docking station and operating in the second mode in response to determining that the computing device is not coupled to the docking station.

2. The method of claim 1, wherein the second data comprises on-screen display data for an on-screen menu, wherein the on-screen display data is obtained from a processor associated with the docking station.

3. The method of claim 2, further comprising:
intercepting, by the docking station, human interface device (HID) commands for the on-screen menu of the display;
controlling, by the processor associated with the docking station, navigation and selection of the on-screen menu using intercepted HID commands; and
outputting, by the processor associated with the docking station, selection data from the selection of the on-screen menu to configure at least one of the display or systems of the docking station.

4. The method of claim 2, wherein the processor associated with the docking station is embedded in the docking station or the processor associated with the docking station is coupled to the docking station via a fourth interface of the docking station.

5. The method of claim 2, wherein the processor associated with the docking station comprises an artificial intelligence (AI) processor.

6. The method of claim 1, wherein the docking station comprises a memory configured to store on-screen display data for output to the display via the third interface of the docking station.

7. The method of claim 1, wherein the second data comprises picture-in-picture (PiP) video data.

8. The method of claim 1, wherein the first data comprises video data, the method further comprising:
providing, by the docking station, the video data to a processor associated with the docking station;
obtaining, by the docking station, modified video data from the processor associated with the docking station after the processor associated with the docking station modifies the video data; and
selectively outputting, by the docking station, the modified video data to the display.

9. The method of claim 1, further comprising:
obtaining, by the docking station, third data via one of the second interface or a fourth interface of the docking station configured to communicate with a peripheral device;
providing, by the docking station, the third data to a processor associated with the docking station;
obtaining, by the docking station, modified third data from the processor associated with the docking station after the processor associated with the docking station modifies the third data; and
outputting, by the docking station, the modified third data to the computing device via the first interface of the docking station.

10. A docking station, comprising:
at least one processor; and
a memory storing instructions that, when executed by the at least one processor, cause the docking station to:
obtain, by the docking station when operating in a first mode of a plurality of modes, first data via a first interface of the docking station, the first interface being configured to couple the docking station to a computing device;
obtain, by the docking station when operating in a second mode of the plurality of modes, second data via a second interface of the docking station; and
selectively output, to a display via a third interface of the docking station that is different from the first interface and the second interface, the first data in response to the docking station operating in the first mode, or the second data in response to the docking station operating in the second mode, or the second data overlaid on at least a portion of the first data in response to the docking station operating in a third mode, wherein the docking station is further caused to determine that the computing device is not coupled to the docking station and to operate in the second mode in response to determining that the computing device is not coupled to the docking station.

11. The docking station of claim 10, wherein the second data comprises on-screen display data for an on-screen menu, wherein the on-screen display data is obtained from a processor associated with the docking station.

12. The docking station of claim 11, wherein execution of the instructions further causes the docking station to:
intercept, by the docking station, human interface device (HID) commands for the on-screen menu of the display;
control, by the at least one processor, navigation and selection of the on-screen menu using intercepted HID commands; and
output, by the processor associated with the docking station, selection data from the selection of the on-screen menu to configure at least one of the display or systems of the docking station.

13. The docking station of claim 11, wherein the at least one processor associated with the docking station is embedded in the docking station or the processor associated with the docking station is coupled to the docking station via a fourth interface of the docking station.

14. The docking station of claim 11, wherein the at least one processor associated with the docking station comprises an artificial intelligence (AI) processor.

15. The docking station of claim 10, wherein the docking station comprises a memory configured to store on-screen display data for output to the display via the third interface of the docking station.

16. The docking station of claim 10, wherein the second data comprises picture-in-picture (PIP) video data.

17. The docking station of claim 10, wherein the first data comprises video data, and wherein execution of the instructions further causes the docking station to:
provide, by the docking station, the video data to a processor associated with the docking station;
obtain, by the docking station, modified video data from the processor associated with the docking station after the processor associated with the docking station modifies the video data; and
selectively output, by the docking station, the modified video data to the display.

18. The docking station of claim 10, wherein execution of the instructions further causes the docking station to:
obtain, by the docking station, third data via one of the second interface or a fourth interface of the docking station configured to communicate with a peripheral device;
provide, by the docking station, the third data to a processor associated with the docking station;
obtain, by the docking station, modified third data from the processor associated with the docking station after the processor associated with the docking station modifies the third data; and
output, by the docking station, the modified third data to the computing device via the first interface of the docking station.

19. A system, comprising:
a display; and
a docking station coupled to the display, the docking station being configured to:
obtain, by the docking station when operating in a first mode of a plurality of modes, first data via a first interface of the docking station, the first interface being configured to couple the docking station to a computing device;
obtain, by the docking station when operating in a second mode of the plurality of modes, second data via a second interface of the docking station; and
selectively output, to the display via a third interface of the docking station that is different from the first interface and the second interface, the first data in response to the docking station operating in the first mode, or the second data in response to the docking station operating in the second mode, or the second data overlaid on at least a portion of the first data in response to the docking station operating in a third mode, wherein the docking station is further configured to determine that the computing device is not coupled to the docking station and to operate in the second mode in response to determining that the computing device is not coupled to the docking station.

20. The system of claim 19, wherein the second data comprises on-screen display data for an on-screen menu, wherein the on-screen display data is obtained from a processor associated with the docking station.
